(19) United States
(12) Patent Application Publication
(10) Pub. No.: US 2004/0011742 A1
(43) Pub. Date: Jan. 22, 2004

(54) Portable water purification device

(76) Inventor: Nae-Wen Kuo, Taipei (TW)

Correspondence Address: Leong C. LEI, PMB#1008, 1867 Ygnacio Valley Rd., Walnut Creek, CA, 94598-3214, US

(21) Appl. No.: 10/383,725

(22) Filed: Mar. 10, 2003

(30) Foreign Application Priority Data
Jul. 17, 2002 (TW) 091115965

(51) Int. Cl. C02F 1/28

(52) U.S. Cl. 210/694; 210/282

(57) ABSTRACT

A portable water purification device is disclosed. The device is used to purify water for drinking and comprises a container which is portable and has an activated carbon, which can purify drinking water and is contained within the container. The purification device is directly placed into the dining water to facilitate and rapidly purify drinking water. All that is required to purify water is to place the device into the drinking water, and said device can easily be disposed of after use.

### BACKGROUND OF THE INVENTION

(a) Technical Field of the Invention

The present invention relates to a water purification device, and in particular, a portable water purification device employing an activated carbon.

(b) Description of the Prior Art

For humans, water is an indispensable element and our water for daily use generally comes from tap water. In the process of water treatment, chlorine is added to kill bacteria therein. However, the problem of residual chlorine is occurred thereby causing unfavorable odor in the water and therefore making it undesirable to drink water directly from the tap. Besides this, in view of the degradation of the environment at present, organic matters within the water will react with chlorine to form by-products such as trihalomethanes (THMs), including CHCl₃, CHBrCl₂, CHBr₂Cl, and CHBr₃. These four compounds are known as TTHMs (Total trihalomethanes). THM is a carcinogen and therefore it is harmful to the human body if it is ingested with drinking water.

Generally, in order to improve the quality of drinking water, a water purifier is installed and the purifier generally comprises an activated carbon filter cartridge to remove the organic contaminants. However, after a period of utilization of the purifier, bacteria will accumulate at the activated carbon and the filter cartridge, together with other supplementary components has to be periodically cleaned. The filtering core will attained a saturation point of absorption after a period of about six months, and it has to be replaced in order to operate normally.

The purifier as mentioned above has achieved the objective of improving the quality of drinking water, but it is rather laborious and cost ineffective to change the filter cartridge. Accordingly, it is an object of the present invention to provide a portable purification device which can solve the drawbacks of the existing purifiers.

### SUMMARY OF THE INVENTION

Accordingly, it is an object of the present invention to provide a portable water purification for purifying drinking water.

Yet another object of the present invention is to provide a portable water purification device, comprising a portable container; and activated carbon having an effect of purifying drinking water and contained within the container, whereby the portable water purification device is directly placed into the drinking water to purify the quality of the drinking water.

A further object of the present invention is to provide a portable water purification device, wherein the container is a package which contains the active carbon.

Another further object of the present invention is to provide a portable water purification device, wherein the package is made from fibrous material.

Yet another object of the present invention is to provide a portable water purification device, wherein the package is a flat bag having the shape of a tea bag.

Yet another object of the present invention is to provide a portable water purification device, wherein the package is a 3D shaped of a tea bag.

Another object of the present invention is to provide a portable water purification device, wherein a pulling thread is connected to the package.

A further object of the present invention is to provide a portable water purification device, wherein the activated carbon is used to absorb residual chlorine and trihalomethanes.

A further object of the present invention is to provide a portable water purification device, wherein trihalomethanes include CHCl₃, CHBrCl₂, CHBr₂Cl and CUBr₃.

A further object of the present invention is to provide a portable water purification device, wherein the specific surface area of the activated carbon is greater than 1200 m²/g.

A further object of the present invention is to provide a portable water purification device, wherein the content of the activated carbon is 2 g.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1A is a perspective view of a portable water purification device according to a first preferred embodiment of the present invention.

FIG. 1B is a perspective view of a portable water purification device according to a second preferred embodiment of the present invention.

FIG. 2 is a graph showing the relation of adsorption time with the concentration of residue free chlorine of the present device.

FIG. 3 is a graph showing the relation of adsorption time with the total concentration of trihalomethane.

FIG. 4 is a graph showing the relation of the adsorption time with high concentration trihalomethane of the present invention.

FIG. 5 is a graph showing the relationship of the adsorption time with the total concentration of the trihalomethane of the present device.

### DETAILED DESCRIPTION OF THE PREFERRED EMBODIMENT

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

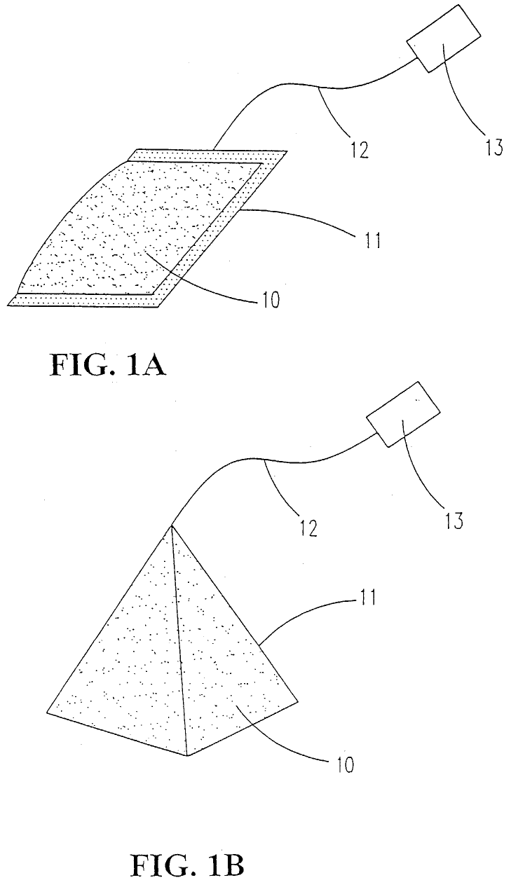

Referring to FIGS. 1A and 1B, there is shown a portable water purification device, wherein an activated carbon 10 is disposed into a container 11, which is permeable and portable to purify drinking water. The container 11 can be a package which is made from a fibrous material, and the package is preferably a flat shape bike that of a teabag or a 3 D shape which is connected with a thread 12 to a piece of paper 13, facilitating withdrawal of the package.

In accordance with a preferred embodiment of the present invention, the package which is permeable containing 2 g of coconut shell active carbon, has the following properties as shown in table 1.

TABLE 1
SPECIFICATION OF ACTIVATED CARBONCONTENT

| Particle diameter | 8 × 30 mesh |
|---|---|
| Vitual s.g. | 0.45-0.48 g/mL |
| CCl₄ adsorption rate | ≧60% |
| — | ≧180 mg/g |
| Iodine value | ≧1150 mg/g |
| Specific surface area | ≧1200 m²/g |
| pH value | 7 |
| Hardness | ≧90% |
| ash | ≦5% |
| water | ≦5% |

In accordance with the present invention, the efficiency of absorption of residual chlorine and THM can be shown by the following working examples.

### WORKING EXAMPLE 1

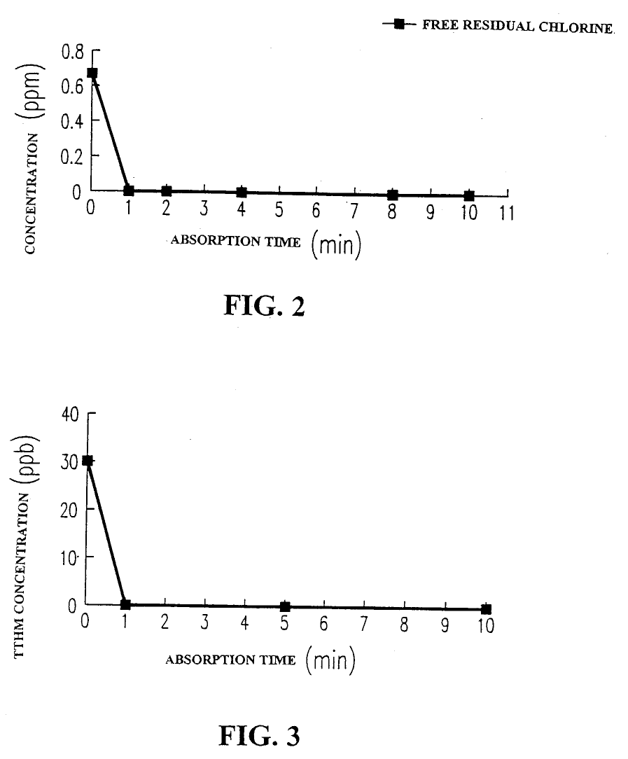

100 ml of drinking water was added with the package in accordance with the present invention, and GC-MASS was used to detect the content of free residual chlorine in the water with respect to the absorption time. FIG. 2 shows the results. Based on the results of FIG. 2, the package of the present invention absorbs all the free residual chlorine within 1 minute. This shows that the portable package can remove chlorine efficaciously.

### WORKING EXAMPLE 2

100 ml of drinking water was added with the package in accordance with the present invention and GC-MASS was used to inspect the TTHM with respect to absorption time. The results of the absorption in FIG. 3 show that the present package is effective in removal of TTHM.

### WORKING EXAMPLE 3

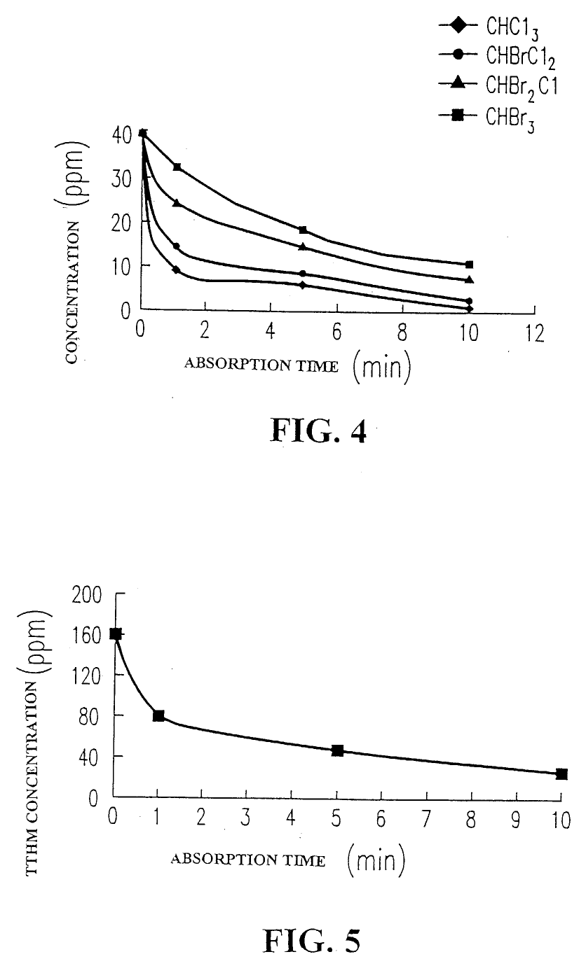

Solutions having 40 ppm high concentration CHCl₃, CHBrCl₂, ChBr₂Cl and CHBr₃were prepared. A package according to the present invention was added to the solution for absorption, and GC-MASS was used to determine the contents of THM in the solution at different absorption time. The result was shown in FIG. 4. The figure indicated that the package provides an excellent adsorption of high concentration THM. If the amounts of the respective THM in FIG. 4 were added, the relationship of the TTHM adsorption content was shown in FIG. 5. This indicates that the package can absorb 80 ppm TTHM within 1 minute.

In view of the above, the present purification device that is portable can purify drinking water within 1 minute by being directly disposed into the drinking water. The package is disposable after use.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable water purification device for purifying to provide purified water for drinking comprising:
a portable container; and
activated carbon having an effect of purifying drinking water and contained within the container,
whereby the portable water purification device is directly placed into the drinking water to purify the quality of the drinking water.

2. The portable water purification device of claim 1, wherein the container is a package which contains the active carbon.

3. The portable water purification device of claim 2, wherein the package is made from fibrous material.

4. The portable water purification device of claim 2, wherein the package is a flat bag having the shape of a tea bag.

5. The portable water purification device of claim 2, wherein the package is a 3D shape of a tea bag.

6. The portable water purification device of claim 2, wherein a pulling thread is connected to the package.

7. The portable water purification device of claim 1, wherein the activated carbon is used to adsorb residual chlorine and trihalomethane.

8. The portable water purification device of claim 6, wherein trihalomethane includes CHCl₃, CHBrCl₂, CHBr₂Cl and CHBr₃.

9. The portable water purification device of claim 1, wherein the specific surface area of the activated carbon is greater than 1200 m²/g.

10. The portable water purification device of claim 1, wherein the content of the activated carbon is 2 g.

11. The portable water purification device of claim 1, wherein the purification device achieves the effect of purification of the drinking water within 1 minute.

12. The portable water purification device of claim 1, wherein the device is used to purify at least 160 liter of the drinking water.

13. A method of purification water using a package of activated carbon characterized in that the package is directly disposed on to the drinking water to purify the drinking water.

14. The method of purification water of claim 13, wherein the activated carbon is placed into a permeable package.

15. The method of purification water of claim 14, wherein the package is made from fibrous material.

16. The method of purification water of claim 14, wherein the package is a flat bag having the shape of a tea bag.

17. The method of purification water of claim 14, wherein the package is a 3D shape of a tea bag.

18. The method of purification water of claim 14, wherein a pulling thread is connected to the package.

19. The method of purification water of claim 13, wherein the activated carbon is used to adsorb residual chlorine and trihalomethane.

20. The method of purification water of claim 19, wherein the trihalomethane includes CHCl₃, CHBrCl₂, CHBr₂Cl and CHBr₃.

21. The method of purification water of claim 13, wherein the specific surface area of the activated carbon is greater than 1200 m²/g.

22. The method of purification water of claim 13, wherein the content of the activated carbon is 2 g.

23. The method of purification water of claim 13, wherein the purification device achieves the effect of purification of the drinking water within 1 minute.

24. The method of purification water of claim 13, wherein the device is used to purify at least 160 liter of the drinking water.
